(19) United States
(12) Patent Application Publication
(10) Pub. No.: US 2016/0021609 A1
(43) Pub. Date: Jan. 21, 2016

(54) METHOD FOR SETTING UP HIGH-SPEED LINK IN WLAN SYSTEM AND APPARATUS FOR SAME

(71) Applicant: LG ELECTRONICS INC., Seoul (KR)

(72) Inventors: Giwon PARK, Anyang-si, Gyeonggi-do (KR); Jaehyung SONG, Anyang-si, Gyeonggi-do (KR); Jinsam KWAK, Anyang-si, Gyeonggi-do (KR); Kiseon RYU, Anyang-si, Gyeonggi-do (KR)

(73) Assignee: LG ELECTRONICS INC., Seoul (KR)

(21) Appl. No.: 14/378,888

(22) PCT Filed: Feb. 14, 2013
(86) PCT No.: PCT/KR2013/001146

§ 371 Date: Aug. 14, 2014

Related U.S. Application Data
(60) Provisional application No. 61/598,344, filed on Feb. 14, 2012.
(60) Provisional application No. 61/598,345, filed on Feb. 14, 2012.
(60) Provisional application No. 61/737,830, filed on Dec. 17, 2012.

(51) Int. Cl. H04W 48/20

(52) U.S. Cl. CPC H04W 48/20; H04W 84/12

(57) ABSTRACT

The present invention relates to a wireless communication system, and more specifically, disclosed are a method and an apparatus for setting up a high-speed link in a WLAN system. A method for a station (STA) setting up the high-speed link in the wireless communication system, according to one embodiment of the present invention, comprises the steps of: scanning and discovering a plurality of access points (APs); transmitting a request frame to a portion or all of the plurality of APs by using a multicast or a broadcast technique; and receiving a response frame from the portion or all of the plurality of APs.

### TECHNICAL FIELD

The following descriptions relate to a wireless communication system and, more specifically, to a method for setting up a fast link in a WLAN system and an apparatus for the same.

### BACKGROUND ART

With the growth of information communication technology, various wireless communication technologies are under development. Among the wireless communication technologies, wireless local area network (WLAN) technology enables wireless Internet access at home or in offices or specific service provision areas using a mobile terminal such as a personal digital assistant (PDA), laptop computer, portable multimedia player (PMP) or the like on the basis of radio frequency technology.

To overcome the limitations of communication rate, which have been blamed for a weak point of WLAN, recent technical standards have introduced systems with increased network rate and reliability and extended wireless network coverage. For example, IEEE 802.11n supports high throughput (HT) of a data rate of 540 Mbps or higher and introduces MIMO (Multiple Input Multiple Output) technology which uses multiple antennas for both a transmitter and a receiver in order to minimize a transmission error and optimize a data rate.

IEEE 802.11ai is developed as new standards for supporting fast initial link setup for stations (STAs) that support IEEE 802.11 at a MAC (Medium Access Control) layer of IEEE 802.11 systems. IEEE 802.11ai aims to provide technologies for supporting fast link setup in a situation in which so many people leave previously connected WLAN coverage and substantially simultaneously access a new WLAN in the case of public transportation transfer, for example. In addition, IEEE 803.11ai has characteristics of security framework, IP address assignment, fast network discovery, etc.

### DISCLOSURE

### Technical Problem

Technology providing fast link setup (or fast session setup) is required when many users substantially simultaneously attempt network access or a very large number of terminals substantially simultaneously a random access procedure, as described above. However, a detailed scheme for fast link setup has not yet been provided.

An object of the present invention devised to solve the problem lies in a method for remarkably decreasing a time required for a generic advertisement service (GAS) procedure by optimizing the GAS procedure and/or increasing the speed thereof for fast link setup.

The technical problems solved by the present invention are not limited to the above technical problems and those skilled in the art may understand other technical problems from the following description.

### Technical Solution

The object of the present invention can be achieved by providing a method for setting up, by a station (STA), a fast link in a wireless communication system, including: discovering a plurality of access points (APs) through scanning; transmitting a request frame to a portion or all of the APs in a multicast or broadcast manner; and receiving a response frame from the portion or all of the APs.

In another aspect of the present invention, provided herein is a method for supporting, by an AP, fast link setup in a wireless communication system, including: receiving a request frame from an STA; and transmitting a response frame to the STA, wherein the AP is discovered through scanning performed by the STA, wherein the request frame is transmitted from the STA to a portion or all of the APs in a multicast or broadcast manner.

In another aspect of the present invention, provided herein is an STA performing fast link setup in a wireless communication system, including: a transceiver; and a processor, wherein the processor is configured to discover a plurality of APs through scanning, to transmit a request frame to a portion or all of the APs in a multicast or broadcast manner using the transceiver and to receive a response frame from the portion or all of the APs using the transceiver.

In another aspect of the present invention, provided herein is an AP supporting fast link setup in a wireless communication system, including: a transceiver; and a processor, wherein the processor is configured to receive a request frame from an STA using the transceiver and to transmit a response frame to the STA using the transceiver, wherein the AP is discovered through scanning performed by the STA, wherein the request frame is transmitted from the STA to a portion or all of the APs in a multicast or broadcast manner.

The following is commonly applicable to the aforementioned embodiments of the present invention.

An AP to be associated with the STA may be selected on the basis of network service information included in the received response frame.

The network service information may be obtained through query request and response operations performed by the portion or all of the APs for an advertisement server (AS).

The query request and response operations for the AS may be performed in parallel by the portion or all of the APs.

The response frame may be received in parallel from the portion or all of the APs.

The request frame may include one or more service set identifier (SSID) information elements, wherein the portion or all of the APs correspond to one or more SSIDs included in the one or more SSID information elements.

The request frame may include one or more basic service set identifier (BSSID) information elements, wherein the portion or all of the APs correspond to one or more BSSIDs included in the one or more BSSID information elements.

A receiving address field of a medium access control (MAC) header of the request frame may be set to a wildcard value.

A body of the request frame may include identification information identifying the portion or all of the APs.

The identification information may be a target SSID list.

When the identification information has a wildcard value, the request frame may be transmitted to all the APs and the response frame may be received from all the APs.

The request frame may be a generic advertisement service (GAS) initial request frame and the response frame may be a GAS initial response frame.

The above description and the following detailed description of the present invention are exemplary and are for additional explanation of the invention disclosed in the claims.

### Advantageous Effects

According to the present invention, it is possible to provide a method and an apparatus for remarkably decreasing a time required for a GAS procedure by optimizing the GAS procedure and/or increasing the speed thereof, thereby performing or supporting fast link setup.

The effects of the present invention are not limited to the above-described effects and other effects which are not described herein will become apparent to those skilled in the art from the following description.

### DESCRIPTION OF DRAWINGS

The accompanying drawings, which are included to provide a further understanding of the invention, illustrate embodiments of the invention and together with the description serve to explain the principle of the invention. In the drawings:

FIG. 1 illustrates an exemplary configuration of an IEEE 802.11 system to which the present invention is applicable;

FIG. 2 illustrates another exemplary configuration of an IEEE 802.11 system to which the present invention is applicable;

FIG. 3 illustrates another exemplary configuration of an IEEE 802.11 system to which the present invention is applicable;

FIG. 4 illustrates an exemplary configuration of a WLAN system;

FIG. 5 illustrates a general link setup procedure;

FIG. 6 illustrates state transition of an STA;

FIG. 7 illustrates a GAS procedure;

FIG. 8 illustrates an example of an enhanced GAS procedure provided by the present invention;

FIG. 9 illustrates another example of the enhanced GAS procedure provided by the present invention;

FIGS. 10 and 11 illustrate formats of new information elements provided by the present invention;

FIG. 12 illustrates a conventional unicast GAS query request;

FIG. 13 illustrates a multicast/broadcast GAS request scheme provided by the present invention;

FIG. 14 illustrates formats of new information elements provided by the present invention;

FIG. 15 illustrates an exemplary MAC frame structure of a multicast/broadcast GAS request frame according to the present invention;

FIG. 16 is a block diagram illustrating exemplary configurations of an AP and an STA according to an embodiment of the present invention; and

FIG. 17 illustrates an exemplary configuration of a processor of an AP or an STA according to an embodiment of the present invention.

### BEST MODE

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

Embodiments described hereinbelow are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions of another embodiment.

Specific terms used in the embodiments of the present invention are provided to aid in understanding of the present invention. These specific terms may be replaced with other terms within the scope and spirit of the present invention.

In some cases, to prevent the concept of the present invention from being obscured, structures and apparatuses of the known art will be omitted, or will be shown in the form of a block diagram based on main functions of each structure and apparatus. In addition, wherever possible, the same reference numbers will be used throughout the drawings and the specification to refer to the same or like parts.

The embodiments of the present invention can be supported by standard documents disclosed for at least one of wireless access systems, Institute of Electrical and Electronics Engineers (IEEE) 802, 3GPP, 3GPP LTE, LTE-A, and 3GPP2. Steps or parts that are not described to clarify the technical features of the present invention can be supported by those documents. Further, all terms as set forth herein can be explained by the standard documents.

Techniques described herein can be used in various wireless access systems such as Code Division Multiple Access (CDMA), Frequency Division Multiple Access (FDMA), Time Division Multiple Access (TDMA), Orthogonal Frequency Division Multiple Access (OFDMA), Single Carrier-Frequency Division Multiple Access (SC-FDMA), etc. CDMA may be implemented as a radio technology such as Universal Terrestrial Radio Access (UTRA) or CDMA2000. TDMA may be implemented as a radio technology such as Global System for Mobile communications (GSM)/General Packet Radio Service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, Evolved-UTRA (E-UTRA) etc. For clarity, this application focuses on the IEEE 802.11 system. However, the technical features of the present invention are not limited thereto.

Configuration of WLAN System

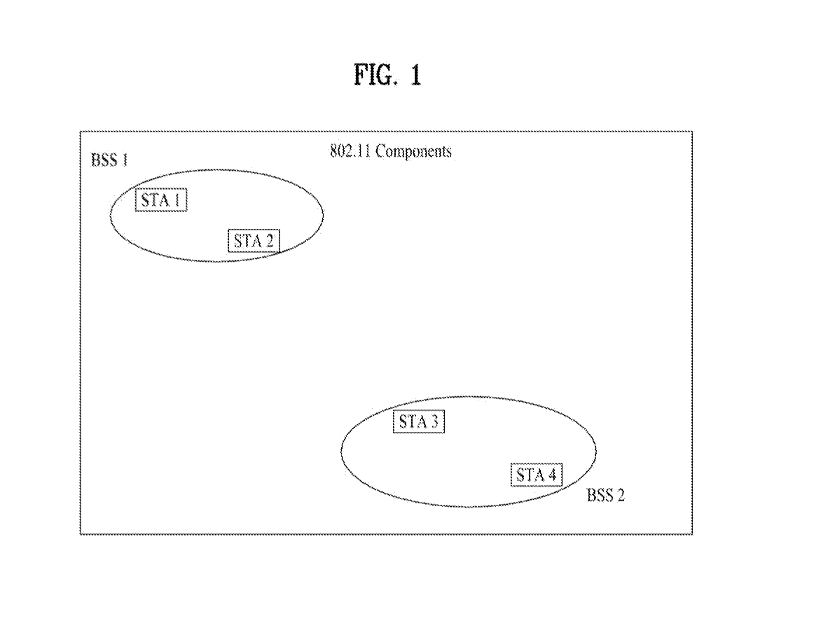

FIG. 1 illustrates an exemplary configuration of an IEEE 802.11 system to which the present invention is applicable.

IEEE 802.11 can be composed of a plurality of components and provide a WLAN supporting STA mobility transparent for higher layers according to interaction of the components. A basic service set (BSS) may correspond to a basic component block in an IEEE 802.11 LAN. FIG. 1 shows 2 BSSs (BSS1 and BSS2) each of which includes 2 STAs as members (STA1 and STA2 being included in BSS1 and STA3 and STA4 being included in BSS2). In FIG. 1, an oval that defines a BSS indicates a coverage area in which STAs belonging to the corresponding BSS perform communication. This area may be called a basic service area (BSA). When an STA moves out of the BSA, the STA cannot directly communicate with other STAs in the BSA.

A most basic BSS in the IEEE 802.11 LAN is an independent BSS (IBSS). For example, the IBSS can have a minimum configuration including only 2 STAs. The IBSS has a simplest form and corresponds to the BSS (BSS1 or BSS2) shown in FIG. 1, in which components other than STA are omitted. This configuration is possible when STAs can directly communicate with each other. This type of LAN can be configured as necessary rather than being previously designed and configured and may be called an ad-hoc network.

When an STA is turned on or off, or enters or exits the coverage of a BSS, membership of the STA in the BSS can be dynamically changed. To become a member of the BSS, the STA can join the BSS using a synchronization process. To access all services based on the BSS, the STA needs to associate with the BSS. Association may be dynamically set and may use a distribution system service (DSS).

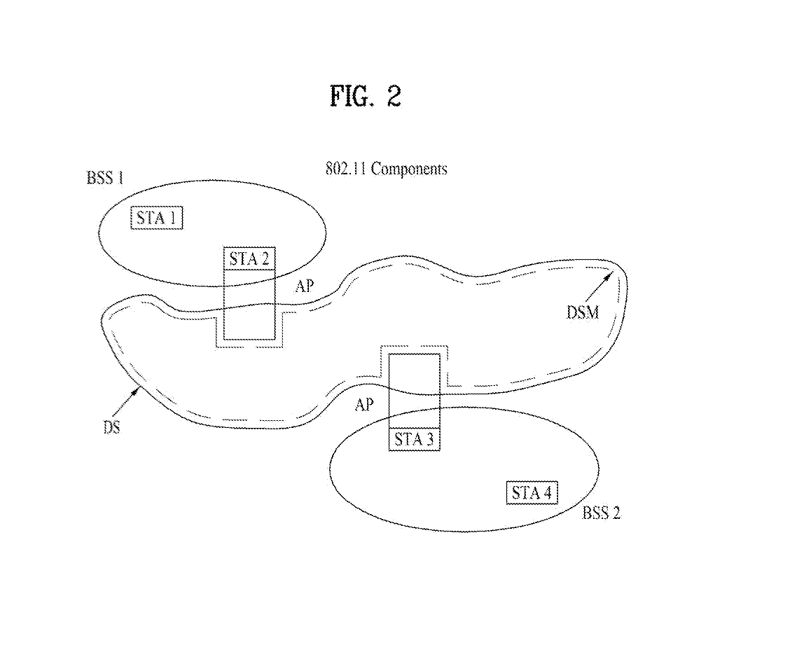

FIG. 2 illustrates another exemplary configuration of an IEEE 802.11 system to which the present invention is applicable. FIG. 2 shows a distribution system (DS), a distribution system medium (DSM) and an access point (AP) in addition to the configuration of FIG. 1.

In a LAN, a direct station-to-station distance may be limited by PHY performance. While this distance limit can be sufficient in some cases, communication between stations having a long distance therebetween may be needed in some cases. The DS may be configured to support an extended coverage.

The DS refers to a structure in which BSSs are connected to each other. Specifically, BSSs may be present as components of an extended form of a network composed of a plurality of BSSs rather than being independently present as shown in FIG. 1.

The DS is a logical concept and may be specified by characteristics of the DSM. IEEE 802.11 logically discriminates a wireless medium (WM) from the DSM. The logical media are used for different purposes and used by different components. IEEE 802.11 does not limit the media as the same medium or different media. The fact that plural media are logically different from each other can explain flexibility of IEEE 802.11 LAN (DS structure or other network structures). That is, the IEEE 802.11 LAN can be implemented in various manners and physical characteristics of implementations can independently specify corresponding LAN structures.

The DS can support mobile devices by providing seamless integration of a plurality of BSSs and logical services necessary to handle addresses to a destination.

The AP refers to an entity that enables associated STAs to access the DS through a WM and has STA functionality. Data can be transmitted between a BSS and the DS through the AP. For example, STA2 and STA3 shown in FIG. 2 have STA functionality and provide a function of enabling associated STAs (STA1 and STA4) to access the DS. Furthermore, all APs are addressable entities because they basically correspond to an STA. An address used by an AP for communication on the WM is not necessarily equal to an address used by the AP for communication on the DSM.

Data transmitted from one of STAs associated with an AP to an STA address of the AP can be received at an uncontrolled port at all times and processed by an IEEE 802.1X port access entity. Furthermore, the transmitted data (or frame) can be delivered to the DS when a controlled port is authenticated.

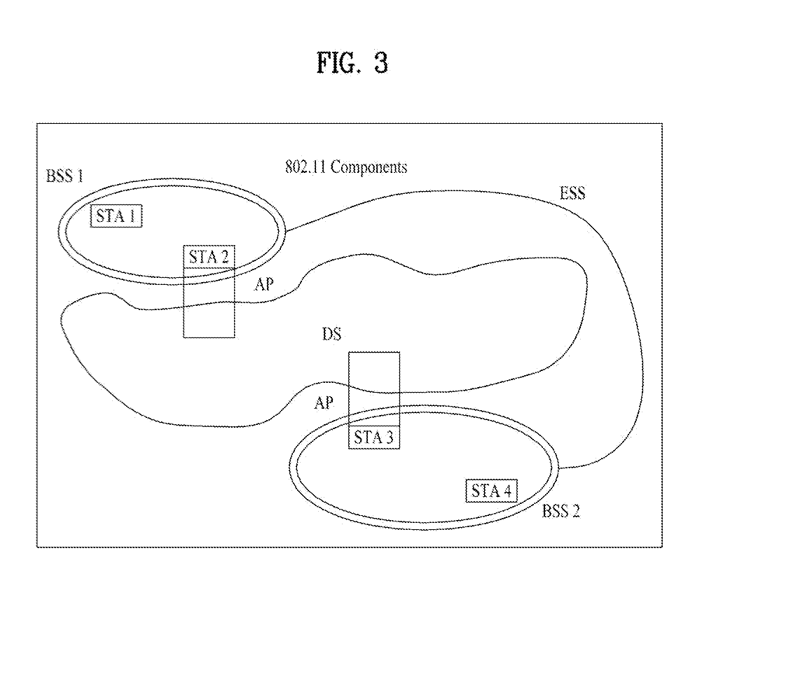

FIG. 3 illustrates another exemplary configuration of an IEEE 802.11 system to which the present invention is applicable. FIG. 3 shows an extended service set (ESS) for providing an extended coverage in addition to the configuration of FIG. 2.

A wireless network having an arbitrary size and complexity may be composed of a DS and BSSs. This type of network is called an ESS network in IEEE 802.11. The ESS may correspond to a set of BSSs connected to a DS. However, the ESS does not include the DS. The ESS network looks like an IBSS network at a logical link control (LLC) layer. STAs belonging to the ESS can communicate with each other and mobile STAs can move from a BSS to another BSS (in the same ESS) transparently to LCC.

IEEE 802.11 does not define relative physical positions of BSSs in FIG. 3 and the BSSs may be located as follows. The BSSs can partially overlap, which is a structure normally used to provide continuous coverage. The BSSs may not be physically connected to each other and there is a limit on the logical distance between the BSSs. In addition, the BSSs may be physically located at the same position in order to provide redundancy. Furthermore, one (or more) IBSS or ESS networks may be physically located in the same space as one (or more ESS) network. This may correspond to an ESS network form when an ad-hoc network operates in the location of the ESS network, IEEE 802.11 networks, which physically overlap, are configured by different organizations or two or more different access and security policies are needed at the same position.

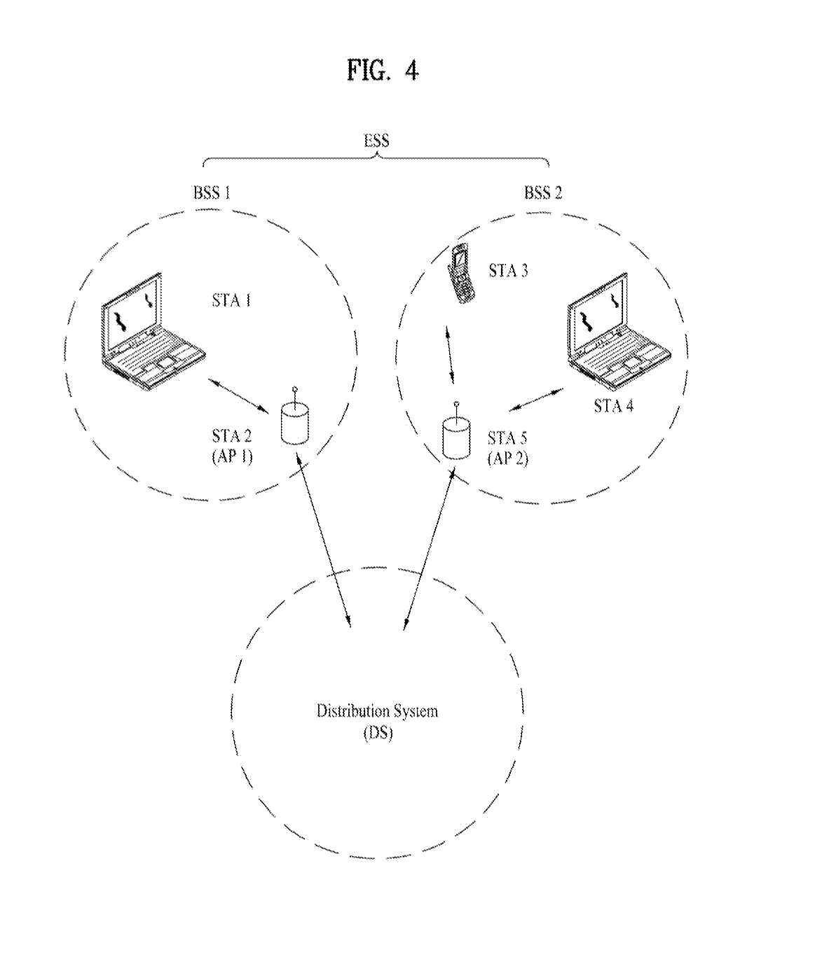

FIG. 4 illustrates an exemplary configuration of a WLAN system. FIG. 4 shows an example of a BSS based on a structure including a DS.

In the example of FIG. 4, BSS1 and BSS2 constitute an ESS. In the WLAN system, STAs are devices operating according to MAC/PHY regulations of IEEE 802.11. The STAs include an AP STA and a non-AP STA. The non-AP STA corresponds to a device directly handled by a user, such as a laptop computer, a cellular phone, etc. In the example of FIG. 4, STA1, STA3 and STA4 correspond to the non-AP STA and STA2 and STA5 correspond to the AP STA.

In the following description, the non-AP STA may be called a terminal, wireless transmit/receive unit (WTRU), user equipment (UE), mobile station (MS), motile terminal, mobile subscriber station (MSS), etc. The AP corresponds to a base station (BS), node-B, evolved node-B, base transceiver system (BTS), femto BS, etc in other wireless communication fields.

Link Setup Procedure

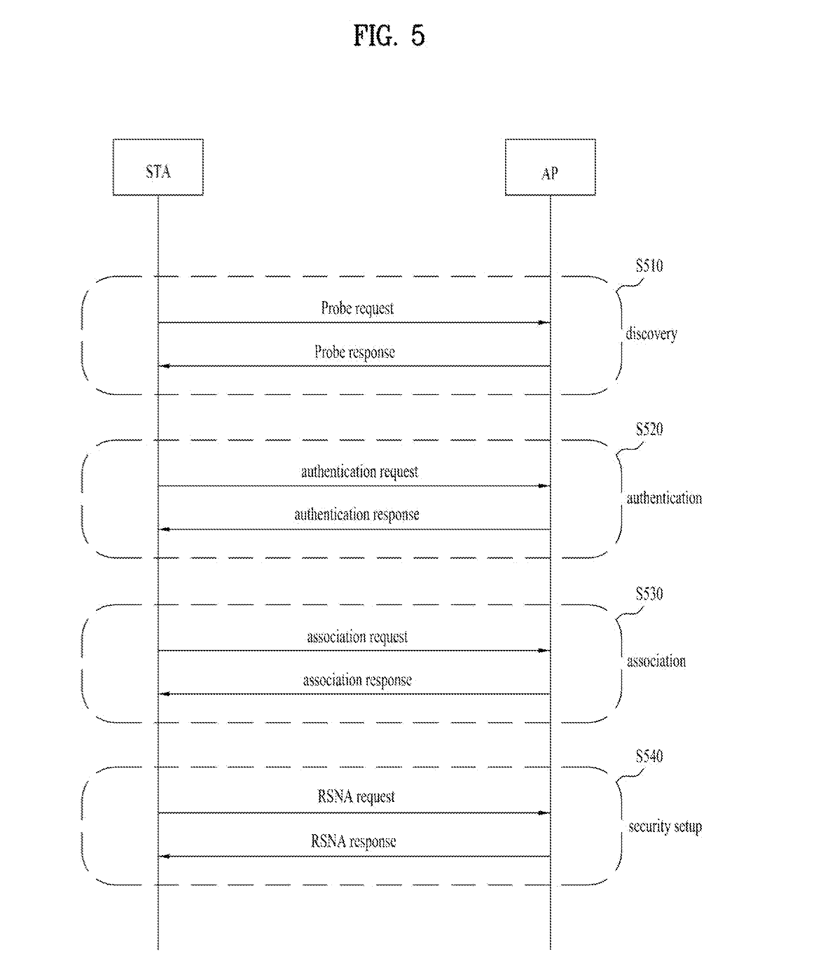

FIG. 5 illustrates a general link setup procedure.

To sets up a link to a network and transmit/receive data, an STA needs to discover the network, perform authentication, establish association and pass through an authentication procedure for security. The link setup procedure may be called a session initiation procedure and a session setup procedure. In addition, discovery, authentication, association and security establishment of the link setup procedure may be called an association procedure.

An exemplary link setup procedure will now be described with reference to FIG. 5.

The STA may discover a network in step S510. Network discovery may include a scanning operation of the STA. That is, the STA needs to discover a network that can participate in communication in order to access the network. The STA needs to identify a compatible network prior to participating in a wireless network. A procedure of identifying a network present in a specific area is referred to as scanning.

Scanning includes active scanning and passive scanning.

FIG. 5 illustrates network discovery operation including active scanning. The STA performing active scanning transmits a probe request frame in order to search surrounding APs while changing channels and waits for a response to the probe request frame. A responder transmits a probe response frame in response to the probe request frame to the STA. Here, the responder may be an STA that has finally transmitted a beacon frame in a BSS of a channel being scanned. An AP corresponds to a responder in a BSS since the AP transmits a beacon frame, whereas a responder is not fixed in an IBSS since STAs in the IBSS transmit a beacon frame in rotation. For example, an STA, which has transmitted a probe request frame on channel #1 and has received a probe response frame on channel #1, may store BSS related information included in the received probe response frame, move to the next channel (e.g. channel #2) and perform scanning (i.e. probe request/response transmission and reception on channel #2) in the same manner.

The scanning operation may be performed in a passive scanning manner, which is not shown in FIG. 5. An STA performing passive scanning waits for a beacon frame while changing channels. The beacon frame, one of management frames in IEEE 802.11, indicates presence of a wireless network and is periodically transmitted to the STA performing scanning to enable the STA to discover and participate in the wireless network. An AP periodically transmits the beacon frame in the BSS, whereas STAs in the IBSS transmit the beacon frame in rotation in the case of IBSS. Upon reception of the beacon frame, the STA performing scanning stores information about the BSS, included in the beacon frame, and records beacon frame information in each channel while moving to another channel. The STA that has received the beacon frame may store BSS related information included in the received beacon frame, move to the next channel and perform scanning on the next channel through same method.

Comparing active scanning with passive scanning, active scanning has advantages of smaller delay and lower power consumption than passive scanning.

Upon discovery of the network, authentication may be performed on the STA in step S520. This authentication procedure may be referred to as first authentication to be discriminated from security setup operation of step S540, which will be described later.

Authentication includes a procedure through which the STA transmits an authentication request frame to the AP and a procedure through which the AP transmits an authentication response frame to the STA in response to the authentication request frame. An authentication frame used for authentication request/response corresponds to a management frame and may include information as shown in Table 1.

TABLE 1

| Order | Information | Notes |
|---|---|---|
| 1 | Authentication algorithm | |
| | number | |
| 2 | Authentication transaction | |
| | sequence number | |
| 3 | Status code | The status code information is reserved in certain |
| | | Authentication frames. |
| 4 | Challenge text | The challenge text element is present only in certain |
| | | Authentication frames. |
| 5 | RSN | The RSNE is present in the FT Authentication frames. |
| 6 | Mobility Domain | The MDE is present in the FT Authentication frames. |
| 7 | Fast BSS Transition | An FTE is present in the FT Authentication frames. |
| 8 | Timeout Interval | A Timeout Interval element (TIE) containing the |
| | (reassociation deadline) | reassociation deadline interval is present in the FT |
| | | Authentication frames. |
| 9 | RIC | A Resource Information Container, containing a |
| | | variable number of elements, is present in the FT |
| | | Authentication frames. |
| 10 | Finite Cyclic Group | An unsigned integer indicating a finite cyclic group. |
| | | This is present in SAE authentication frames |
| 11 | Anti-Clogging Token | A random bit-string used for anti-clogging purposes. |
| | | This is present in SAE authentication frames. |
| 12 | Send-Confirm | A binary encoding of an integer used for anti-replay |
| | | purposes. This is present in SAE authentication frames |
| 13 | Scalar | An unsigned integer encoded. This is present in SAE |
| | | authentication frames |
| 14 | Element | A field element from a finite field encoded. This is |
| | | present in SAE authentication frames |
| 15 | Confirm | An unsigned integer encoded. This is present in SAE |
| | | authentication frames |
| Last | Vendor Specific | One or more vendor-specific elements are optionally |
| | | present. These elements follow all other elements. |

In Table 1, the authentication algorithm number field indicates a single authentication algorithm, and has a length of 2 octets. For example, authentication algorithm number field values 0, 1, 2 and 3 respectively indicate an open system, a shared key, fast BSS transition and simultaneous authentication of equals (SAE).

The authentication transaction sequence number field indicates a current status from among multiple transaction steps and has a length of 2 octets.

The status code field is used in a response frame, indicates success or failure of a requested operation (e.g. authentication request) and has a length of 2 octets.

The challenge text field includes a challenge text in authentication exchange and has a length determined according to authentication algorithm and transaction sequence number.

The RSN (Robust Security Network) field includes cipher related information and has a length of up to 255 octets. An RSNE (RSN Element) is included in an FT (Fast BSS Transition) authentication frame. The mobility domain field includes mobility domain identifier MD ID, FT capability and policy fields and may be used for an AP to advertise an AP group (i.e. a set of APs that form a mobility domain) to which the AP belongs. The fast BSS transition field includes information necessary to perform an FT authentication sequence during fast BSS transition in an RSN. The timeout interval field includes a reassociation deadline interval. The resource information container (RIC) field refers to a set of one or more elements related to a resource request/response and may include a varying number of elements (i.e. elements indicating resources).

The finite cyclic group field indicates a cryptographic group used in SAE exchange and has an unsigned integer value indicating a finite cyclic group. The anti-clogging token field is used for SAE authentication for protecting denial-of-service and is composed of a random bit string. The send-confirm field is used for response prevention in SAE authentication and has a binary coded integer. The scalar field is used for exchange cipher related information in SAE authentication and has an encoded unsigned integer. The element field is used for exchange of a finite field element in SAE authentication. The confirm field is used to verify possession of an encryption key in SAE authentication and has an encoded unsigned integer.

The vendor specific field may be used for vendor-specific information that is not defined in IEEE 802.11.

Table 1 shows some information that may be included in an authentication request/response frame and the authentication request/response frame may further include additional information.

The STA may transmit the authentication request frame including one or more fields shown in Table to the AP. That AP may determine to permit authentication of the STA on the basis of information included in the received authentication request frame. The AP may provide an authentication result to the STA through the authentication response frame including one or more fields shown in Table 1.

Upon successful authentication of the STA, association may be performed in step S530. Association includes a procedure through which the STA transmits an association request frame to the AP and a procedure through which the AP transmits an association response frame to the STA in response to the association request frame.

For example, the association request frame may include information related to various capabilities, a beacon listen interval, a service set identifier (SSID), supported rates, supported channels, RSN, mobility domain, supported operating classes, TIM (Traffic Indication Map) broadcast request, interworking service capability, etc.

For example, the association response frame may include information related to various capabilities, a status code, AID (Association ID), supported rates, EDCA (Enhanced Distributed Channel Access) parameter set, RCPI (Received Channel Power Indicator), RSNI (Received Signal to Noise Indicator), mobility domain, timeout interval (association comeback time), overlapping BSS scan parameter, TIM broadcast response, QoS map, etc.

The aforementioned information is part of information that may be included in the association request/response frame and additional information may be further included in the association request/response frame.

Upon successful association of the STA with the network, security setup may be performed in step S540. Security setup in step S540 may be regarded as authentication through an RSNA (Robust Security Network Association) request/response. Authentication of step S520 may be referred to as first authentication and security setup of step S540 may be referred to as authentication.

Security setup of step S540 may include private key setup through 4-way handshaking using an EAPOL (Extensible Authentication Protocol over LAN) frame. In addition, security setup may be performed according to a security scheme that is not defined in IEEE 802.11.

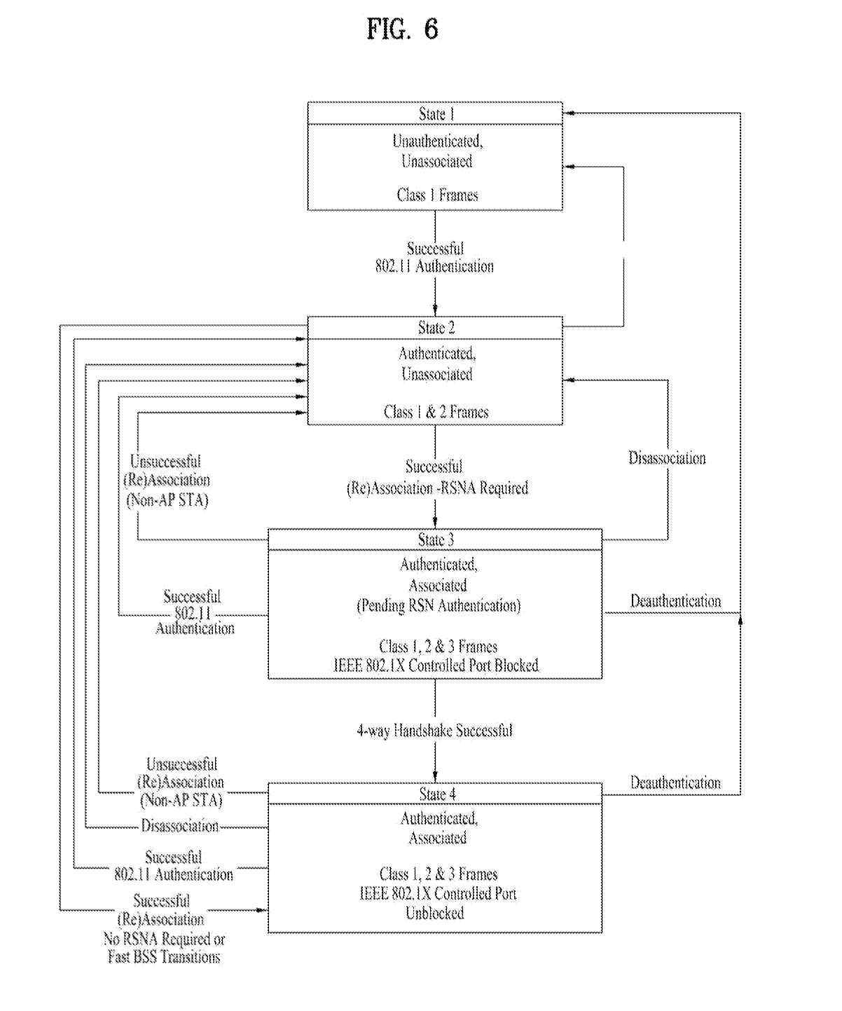

FIG. 6 illustrates the concept of state transition of an STA. FIG. 6 shows only events causing state transition for clarity.

State 1 is an unauthenticated and unassociated state of the STA. The STA in this state can transmit/receive class-1 frames only to/from other STAs. The class-1 frames include management frames such as a probe request/response frame, beacon frame, authentication frame, deauthentication frame and the like, for example.

Upon successful authentication of the STA in state 1 (e.g. authentication corresponding to S520 of FIG. 5), station 1 is changed to state 2. That is, state 2 is an authenticated but unassociated state. The STA in state 2 can transmit/receive class-1 and class-2 frames only to/from other STAs. The class-2 frames include management frames such as an association request/response frame, reassociation request/response frame, diassociation frame and the like, for example.

When the STA in state 2 is deauthenticated, state 2 is changed to state 1. When the STA in state 2 is successfully associated and RSNA is not required or in the case of fast BSS transition, state 2 is directly changed to state 4.

Upon successful association (or reassociation) of the STA in state 2, state 2 is changed to state 3. That is, state 3 is an authenticated and associated state in which RSNA authentication (e.g. security setup corresponding to step S540 of FIG. 5) is not completed. While the STA can transmit/receive class-1, 2 and 3 frames to/from other STAs in state 3, an IEEE 802.1x control port is blocked. Class-3 frames include management frames such as a data frame, action frame and the like and control frames such as a block ACK frame and the like, transmitted/received in an infrastructure BSS.

When the STA is deassociated or fails to be associated in state 3, state 3 is returned to state 2. When the STA is deauthenticated in state 3, state 3 is returned to state 1.

Upon successful 4-way handshaking of the STA in state 3, state 3 is changed to state 4. In state 4, the STA is authenticated and associated and thus can transmit class-1, 2 and 3 frames, and the IEEE 802.1x control port is unblocked.

When the STA is deassociated or fails to be associated in state 4, state 4 is returned to state 2. When the STA is deauthenticated in state 4, state 4 is returned to state 1.

GAS (Generic Advertisement Service) Procedure

A method of advertising an access network type (e.g. private network, free network, charged network, etc.), roaming consortium, location information and the like is used for an STA to discover and select an appropriate network prior to association with an AP (e.g. a system according to IEEE 802.11u standards). In addition, GAS that enables an STA to transmit/receive an advertisement protocol frame (e.g. second layer (Layer 2) or MAC frame) to/from a network server prior to authentication may be used. According to GAS, an AP may function to relay a query of the STA to a network server (e.g. advertisement server (AS)) and to transmit a response from the network server to the STA. In addition, an access network query protocol (ANQP) may be used to acquire various types of network information that the STA desires.

Specifically, the ANQP may be indicated in a GAS query frame to request information about an access network that the STA desires. Accordingly, the STA can obtain network service information (e.g. service information provided by an IBSS, local access service information, available subscription service provider, external network information, etc.) that is not provided through a beacon frame or a probe response frame.

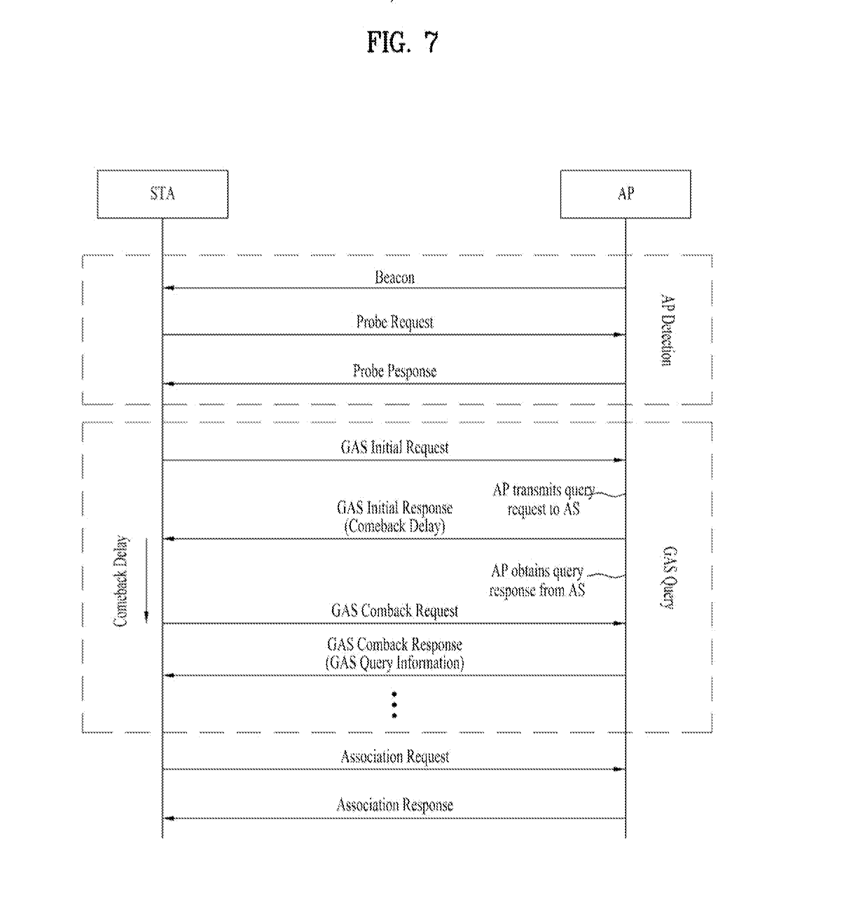

FIG. 7 illustrates a GAS procedure.

An STA may detect an AP by performing passive scanning of receiving a beacon frame or active scanning of transmitting a probe request frame and receiving a frame response frame. The beacon frame or the probe response frame may include information such as an interworking element, a roaming consortium element and the like.

To acquire desired additional network information after detection of the AP, the STA may transmit a GAS initial request frame to the AP. The GAS initial request frame may include a dialog token, request IE and the like. Accordingly, the AP may transmit a GAS query request to an advertisement server (AS). When the AP does not receive a GAS query response from the AS for a predetermined time, the AP may transmit a GAS initial response frame including a dialog token, comeback delay information and the like to the STA. Accordingly, the STA may transmit a GAS comeback request frame including a dialog token to the AP after waiting for comeback delay. The AP may receive the GAS query response from the AS while the STA waits for the comeback delay. In this case, the AP may transmit a GAS comeback response frame including a dialog token, GAS query information and the like in response to the GAS comeback request of the STA.

Upon acquisition of network information through GAS query operation, the STA may associate with the AP of the corresponding network.

Enhanced GAS Procedure

In the aforementioned link setup scheme defined in the current wireless communication system (e.g. WLAN system), message exchange through a beacon or probe request/response (i.e. network discovery), authentication request/response (i.e. first authentication), association request/response (i.e. association) and RSNA request/response (i.e. authentication) needs to be performed.

In the conventional link setup procedure, the GAS procedure needs to be performed in order to obtain network information that the STA desires. However, an unnecessary GAS procedure may be performed when the STA knows the network information, resulting in a delay in the initial link setup procedure. For example, when the STA is reassociated with an AP with which the STA was associated, the STA can perform the GAS procedure again according to the operation defined in the conventional wireless communication system. However, when network service information that the STA desires has not been changed/updated, the STA does not newly obtain information through the GAS procedure and the GAS procedure become unnecessary. Accordingly, the present invention provides a new GAS operation scheme capable of improving initial link setup speed by preventing/skipping an unnecessary GAS/ANQP procedure.

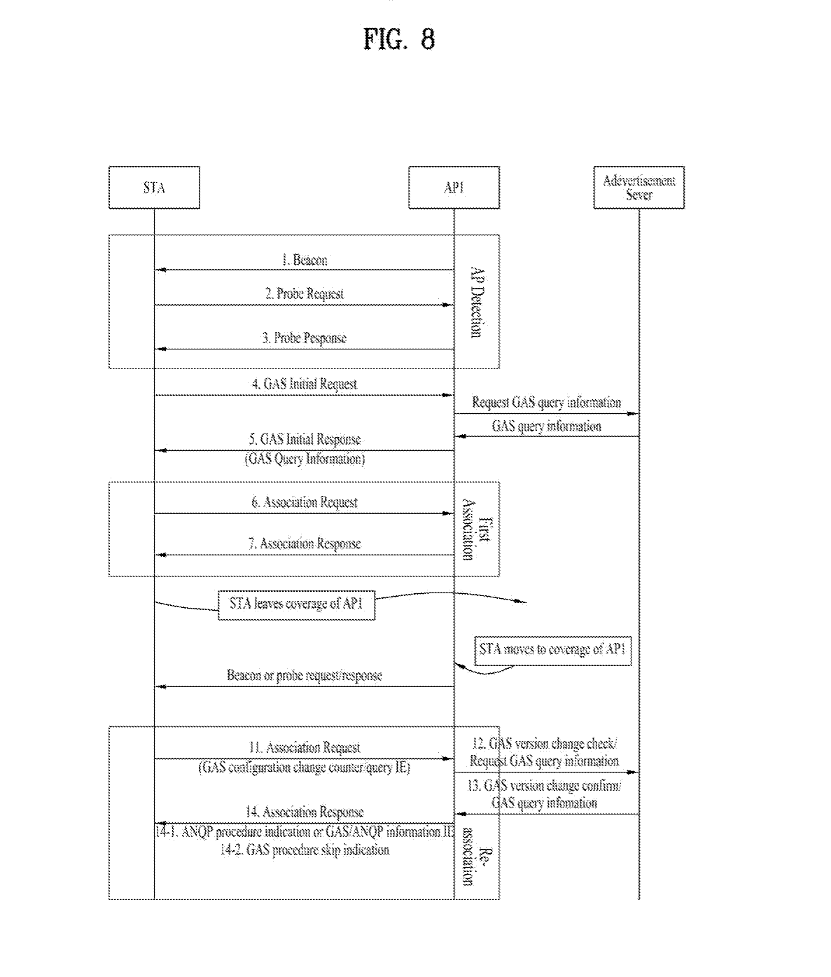

FIG. 8 illustrates an example of an enhanced GAS procedure provided by the present invention.

FIG. 8 illustrates a method of skipping an unnecessary GAS procedure by including GAS configuration change counter and/or GAS configuration change query information in an association request frame. The GAS configuration change counter/query information indicates whether GAS/ANQP information is changed. The GAS configuration change counter information may indicate a value corresponding to a version of the GAS/ANQP information. Changed GAS/ANQP information may have a different GAS configuration change counter value. The GAS configuration change query information is information for inquiring whether GAS/ANQP configuration has been changed and may be regarded as information for requesting a response about whether GAS/ANQP configuration is changed from a receiver (AP or AS).

In steps 1, 2 and 3 of FIG. 8, the STA may discover/detect an AP with which the STA will be associated through reception of a beacon frame or through probe request/response procedure.

In steps 4 and 5 of FIG. 8, the STA may receive GAS/ANQP configuration information (e.g. configuration change counter, GAS/ANQP ID, etc.) along with network service related information through GAS/ANQP procedures prior to association with the AP.

In steps 6 and 7 of FIG. 8, the STA may select AP1 as a preferred AP on the basis of information obtained through the GAS procedure. The STA may perform association with AP1 and access AP1.

In steps 8 and 9 of FIG. 8, it is assumed that the STA leaves the coverage of AP1 and is thus disconnected from AP1 and then enters the coverage of AP1 after a lapse of time.

In step 10 of FIG. 8, the STA may discover/detect an AP to be accessed by performing passive scanning through reception of a beacon frame or active scanning of a probe request/response.

In step 11 of FIG. 8, the STA may select AP1 as an AP to be accessed and perform association with AP1. That is, when steps 6 and 7 correspond to first association, step 11 may be regarded as start of reassociation operation. When the STA performs reassociation with AP1, the STA may include a GAS/ANQP configuration change counter (or GAS/ANQP configuration change query) IE in an association request frame and transmit the association request frame to AP1.

In steps 12 and 13 of FIG. 8, AP1 may check whether GAS version has been changed upon reception of the GAS/ANQP configuration change counter/query IE.

To achieve this, AP1 may obtain GAS/ANQP information from an AS periodically or in an event-triggered manner and locally store and update the GAS/ANQP information. In this case, AP1 may compare the version of the GAS/ANQP information stored therein with the version of GAS/ANQP information stored in the STA (e.g. acquired during the first authentication procedure) to determine whether the two versions match each other, upon reception of the association request frame including a GAS configuration change counter/query from the STA.

Alternatively, upon reception of the association request frame including the GAS configuration change counter/query from the STA, AP1 may request the AS to provide GAS query information and receive the GAS query information from the AS. Accordingly, AP1 may compare the version of the GAS/ANQP information stored in the STA (e.g. acquired during the first authentication procedure) with the version of the GAS/ANQP information obtained from AS to determine whether the two versions match.

Step 14 of FIG. 8 may be performed differently according to whether the version of the GAS/ANQP information stored in the STA corresponds to the version of the GAS/ANQP information stored in AP1 (or obtained from the AS). When the two versions do not match each other, AP1 may transmit, to the STA, an association response frame including indication of execution of a GAS/ANQP procedure or an association response frame including an IE with respect to changed GAS/ANQP information (step 14-1). When the two versions match, AP1 may transmit an association response frame including indication of skipping of the GAS procedure to the STA (step 14-2).

Upon reception of the association response frame, the STA may confirm validity of the GAS/ANQP information stored therein. Accordingly, the STA can perform the GAS/ANQP procedure, change/update the GAS/ANQP information on the basis of the IE containing the GAS/ANQP information, included in the association response frame, or use the GAS/ANQP information stored therein without changing the same.

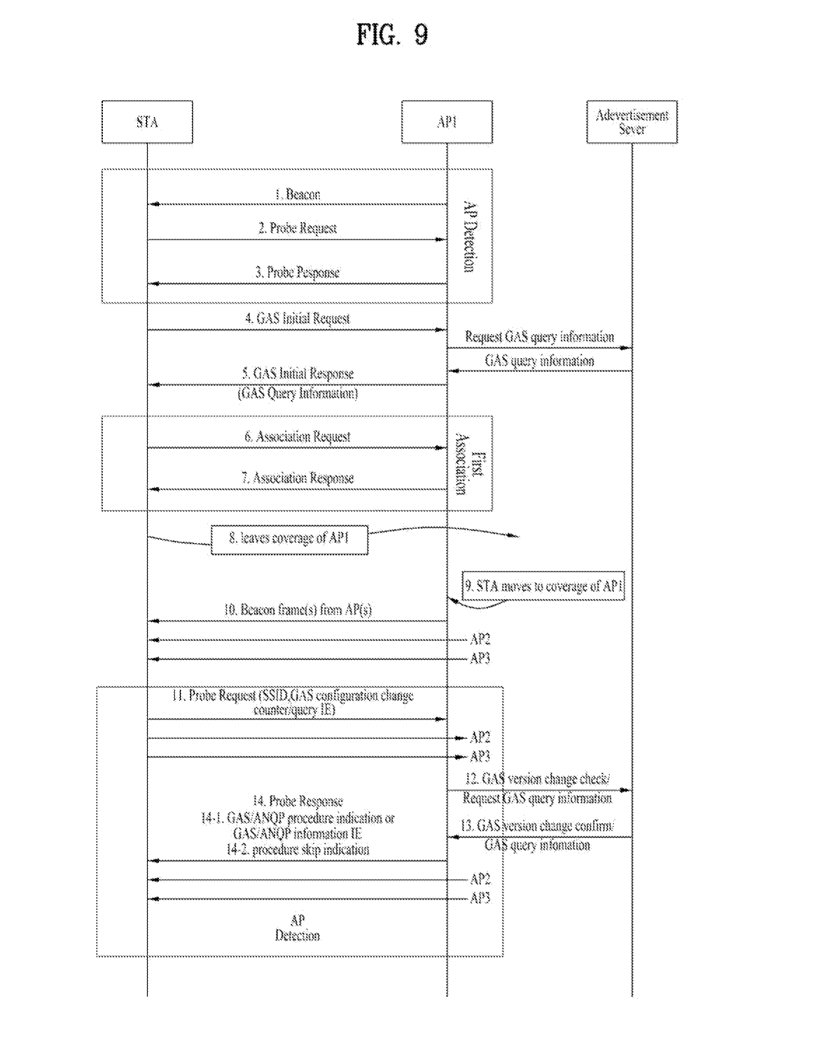

FIG. 9 illustrates another example of the enhanced GAS procedure provided by the present invention.

FIG. 9 illustrates a method of skipping an unnecessary GAS procedure by including GAS configuration change counter (or GAS configuration change query) information in a probe request frame.

Steps 1 to 9 of FIG. 9 correspond to steps 1 to 9 of FIG. 8 and thus redundant description is omitted.

In step 10 of FIG. 9, the STA may receive beacon frames from one or more APs. For example, the STA can respectively receive beacon frames from AP1, AP2 and AP3 to obtain information about AP1, AP2 and AP3.

In step 11 of FIG. 9, the STA may transmit a probe request frame to the one or more APs on the basis of the information about the one or more APs, obtained through the beacon frames, in order to select a preferred AP. The probe request frame may include an SSID (Service Set Identifier) and/or a GAS/ANQP configuration change counter (or GAS/ANQP configuration change query) IE.

In steps 12 and 13 of FIG. 9, upon reception of the probe request frame from the STA, the one or more APs may check whether GAS/ANQP information has been changed (or the version thereof has been changed) when SSID (or SSIDs) thereof corresponds to the SSID included in the probe request frame.

To this end, the one or more APs may obtain GAS/ANQP information from an AS periodically or in an event-triggered manner and locally store and update the GAS/ANQP information. In this case, the one or more APs may compare the version of GAS/ANQP information stored therein with the version of GAS/ANQP information stored in the STA (e.g. acquired during the first authentication procedure) to determine whether the two versions match each other, upon reception of the probe request frame including a GAS configuration change counter/query from the STA.

Alternatively, upon reception of the probe request frame including the GAS configuration change counter/query from the STA, the one or more APs may request the AS to provide GAS query information and receive the GAS query information from the AS. Accordingly, the one or more APs may compare the version of the GAS/ANQP information stored in the STA (e.g. acquired during the first authentication procedure) with the version of the GAS/ANQP information obtained from AS to determine whether the two versions match.

Step 14 of FIG. 9 may be performed differently according to whether the version of the GAS/ANQP information stored in the STA corresponds to the version of the GAS/ANQP information stored in the one or more APs (or obtained from the AS). When the two versions do not match, the one or more APs may transmit, to the STA, a probe response frame including indication of execution of a GAS/ANQP procedure or a probe response frame including an IE with respect to changed GAS/ANQP information (step 14-1). When the two versions correspond to each other, the one or more APs may transmit a probe response frame including indication of skipping of the GAS procedure to the STA (step 14-2).

Upon reception of the association response frame, the STA may confirm validity of the GAS/ANQP information stored therein. Accordingly, the STA can perform the GAS/ANQP procedure, change/update the GAS/ANQP information on the basis of the IE containing the GAS/ANQP information, included in the association response frame, or use the GAS/ANQP information stored therein without changing the same.

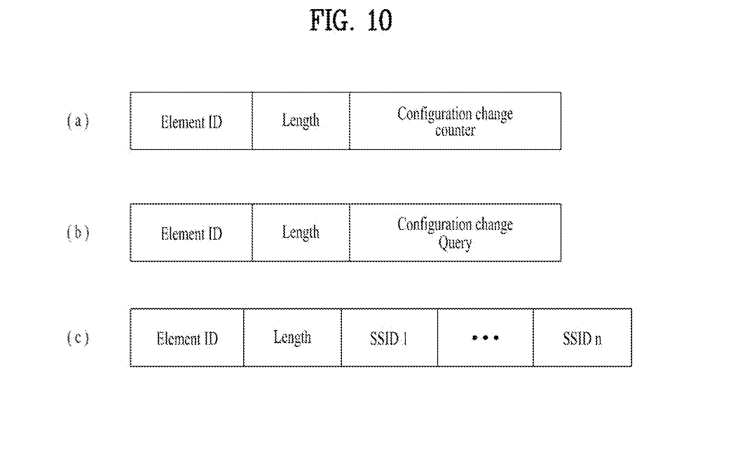

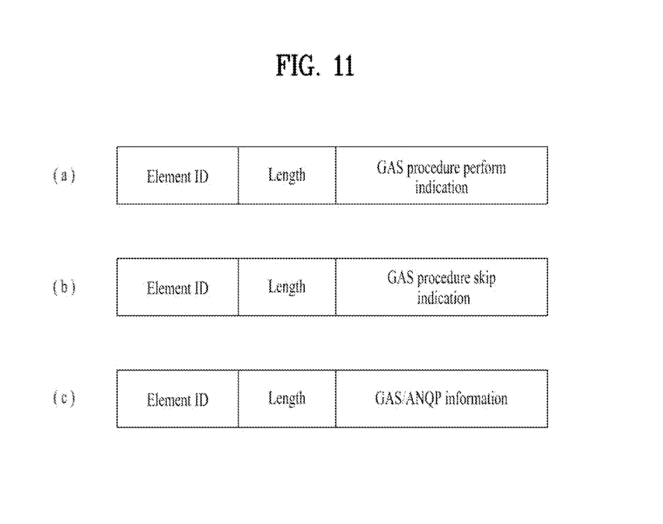

FIGS. 10 and 11 illustrate formats of new information elements (IEs) provided by the present invention.

FIG. 10(a) illustrates an exemplary format of a GAS configuration change counter IE. The element ID field may have a length of 1 octet and may be set to a value indicating that the GAS configuration change counter IE corresponds to GAS configuration change counter information. The length field may be defined to have a length of 1 octet and set to a value indicating the length of the following field. The configuration change counter field may be set to a value indicating the version of GAS/ANQP information stored in the corresponding STA. The GAS configuration change counter IE may be included in an association request frame and/or a probe request frame.

FIG. 10(b) illustrates an exemplary format of a GAS configuration change query IE. The element ID field may have a length of 1 octet and may be set to a value indicating that the GAS configuration change query IE corresponds to a GAS configuration change query. The length field may be defined to have a length of 1 octet and set to a value indicating the length of the following field. The configuration change query field may be set to a value indicating whether GAS/ANQP configuration change is checked and/or a value indicating the version of GAS/ANQP information stored in the corresponding STA. The GAS configuration change query IE may be included in an association request frame and/or a probe request frame.

FIG. 10(c) illustrates an exemplary format of an SSID IE. The element ID field may have a length of 1 octet and may be set to a value indicating that the SSID IE is about an SSID. The length field may be defined to have a length of 1 octet and set to a value indicating the length of the following field. The SSID1, SSID2, . . . , SSIDn fields may be set to values indicating APs that will check whether GAS/ANQP information is changed. When the SSID IE includes only one SSID field, a probe request frame is transmitted (i.e. unicast) to one AP to request the AP to check whether GAS/ANQP information has been changed. When the SSID IE includes a plurality of SSID fields, the probe request frame is transmitted (i.e. multicast) to a plurality of APs to request the APs to check whether GAS/ANQP information has been changed. The SSID IE may be included in a probe request frame.

FIG. 11(a) shows an exemplary format of a GAS procedure perform indication IE. The element ID field may have a length of 1 octet and may be set to a value indicating that the GAS procedure perform indication IE corresponds to GAS procedure perform indication. The length field may be defined to have a length of 1 octet and set to a value indicating the length of the following field. The GAS procedure perform indication field may be set to a value indicating whether the corresponding STA performs a GAS procedure. The GAS procedure perform indication IE may be included in an association response frame and/or a probe response frame.

FIG. 11(b) shows an exemplary format of a GAS procedure skip indication IE. The element ID field may have a length of 1 octet and may be set to a value indicating that the GAS procedure skip indication IE corresponds to GAS procedure skip indication. The length field may be defined to have a length of 1 octet and set to a value indicating the length of the following field. The GAS procedure skip indication field may be set to a value indicating whether the corresponding STA performs or skips a GAS procedure. The GAS procedure skip indication IE may be included in an association response frame and/or a probe response frame.

FIG. 11(c) shows an exemplary format of a GAS/ANQP information IE. The element ID field may have a length of 1 octet and may be set to a value indicating that the GAS/ANQP information IE corresponds to GAS/ANQP information. The length field may be defined to have a length of 1 octet and set to a value indicating the length of the following field. The GAS/ANQP information field may include network service related information (e.g. service information provided by an IBSS, local access service, available subscription service provider, external network information, etc.) transmitted form an AP to the corresponding STA through a GAS initial response frame or a GAS comeback response frame. The GAS/ANQP information IE may be included in an association response frame and/or a probe response frame.

An unnecessary GAS procedure can be determined and skipped using the aforementioned examples of the present invention and/or IE formats to reduce link setup delay. Considering that GAS/ANQP information is not frequently changed/updated compared to other control information, when a network or an AP informs an STA as to whether the GAS/ANQP information has been changed prior to or during provision of the GAS/ANQP information to the STA, unnecessary control information overhead may be generated. Accordingly, the present invention can employ the method through which the STA quires the network or AP as to whether the GAS/ANQP information has been changed as necessary so as to minimize operation of determining whether the GAS/ANQP information has been changed, thereby reducing a load or delay in operations of the network or AP. Accordingly, link setup delay can be remarkably decreased.

Broadcast GAS Request

The present invention additionally provides a method of broadcasting a GAS request frame for reducing link setup delay.

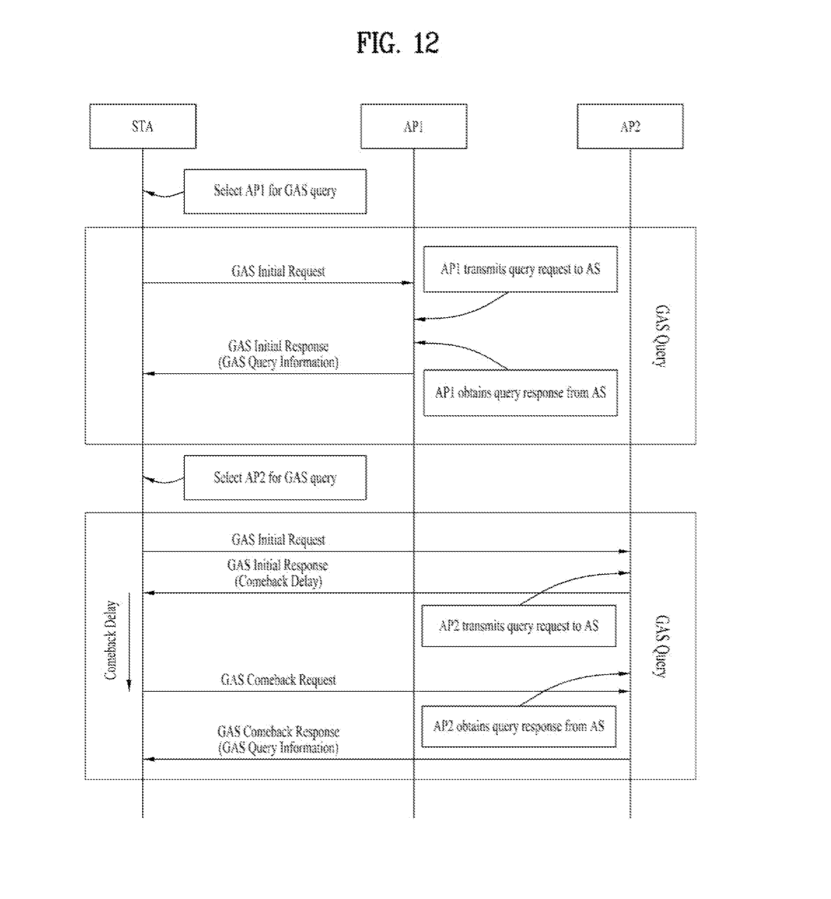

FIG. 12 illustrates a conventional unicast GAS query request.

Prior to steps shown in FIG. 12, an STA may discover/detect one or more APs with which the STA will be associated through active/passive scanning. When the STA discovers a plurality of APs, the STA needs to acquire service information of a network to which each AP belongs in order to determine an AP with which the STA will be associated. To achieve this, a GAS query operation may be performed per AP.

As shown in FIG. 12, when the STA selects AP1 as an AP for which a GAS query will be performed, the STA may transmit a GAS initial request frame to AP1. AP1 may transmit a GAS query request to an AS and obtain a GAS query response from the AS. Accordingly, AP1 may transmit a GAS initial response frame including GAS query information to the STA.

Then, the STA may select AP2 as an AP for which a GAS query will be performed and transmit a GAS initial request frame to AP2. Accordingly, AP2 may transmit a GAS query request to the AS. When AP2 does not receive a GAS query response from the AS until GAS initial response transmission timing, AP2 may transmit a GAS initial response frame including a comeback delay to the STA. Then, AP2 may obtain a GAS query response from the AS. When the STA transmits a GAS comeback request frame to AP2, AP2 may include GAS query information in a GAS comeback response frame and transmit the GAS comeback response frame to the STA in response to the GAS comeback request frame.

Accordingly, the STA that has performed the GAS query operations for AP1 and AP2 may select an appropriate AP with which the STA will be associated and perform an association operation on the selected AP.

When the STA discovers/detects many APs through active/passive scanning, the GAS query operation needs to be performed on many targets in order to determine an AP with which the STA will be associated. In this case, according to a unicast GAS query operation, GAS query operations need to be sequentially performed on a plurality of APs, and thus a time required for the GAS query operations increases as the number of target APs increases. Accordingly, a long delay is generated in a link setup procedure of the STA.

To solve this problem, the present invention provides a multicast/broadcast GAS request frame transmission method. According to this method, a time required for GAS query operation can be remarkably reduced. Particularly, the advantageous effect achieved by the present invention can be maximized in an environment including a large number of APs/networks on which the GAS query operation is performed.

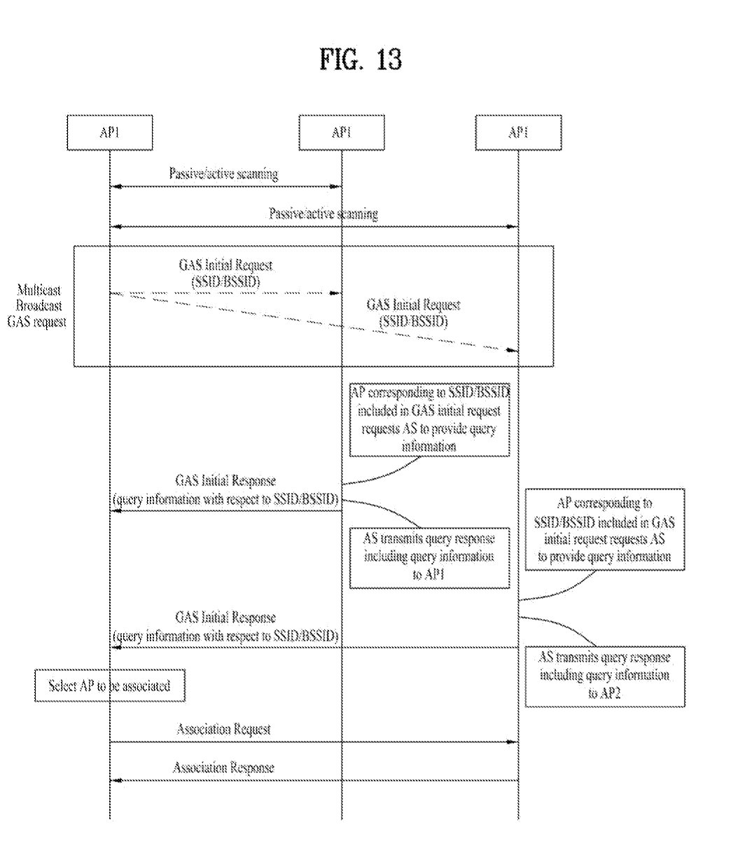

FIG. 13 illustrates the multicast/broadcast GAS request method provided by the present invention.

Referring to FIG. 13, an STA may discover/detect AP1 and AP2 as APs with which the STA will be associated through active/passive scanning.

According to the present invention, the STA may multicast/broadcast a GAS request frame to AP1 and AP2. For multicast/broadcast transmission, the GAS request may include identifiers (e.g. SSIDs and/or basic service set identifiers (BSSIDs) of APs that need to respond to the GAS request frame. Accordingly, even when the STA transmits only one GAS request frame, AP1 and AP2 can respectively receive the GAS request frame.

Upon reception of the GAS request frame, AP1 and AP2 may check whether the SSIDs and/or BSSIDs included in the GAS request frame match SSIDs and/or BSSIDs thereof and perform GAS query request/response operations for the AS when the SSIDs and/or BSSIDs included in the GAS request frame match the SSIDs and/or BSSIDs thereof. Upon acquisition of GAS query information from the AS, AP1 and AP2 may transmit the obtained GAS query information to the STA through a GAS initial response frame. That is, AP1 and AP2 can provide information about GAS query responses for the SSIDs and/or BSSIDs with respect to the GAS query of the STA to the STA using the GAS initial response frame. AP1 and AP2 may perform GAS query request and response operations for the AS in parallel. Accordingly, the operations of AP1 and AP2 to provide service information of networks to which AP1 and AP2 belong to the STA through the GAS initial response frame may be performed in parallel.

Upon reception of the GAS query information from AP1 and AP2, the STA may select an AP suitable for the state of the STA and associate with the selected AP. In the example of FIG. 13, the STA selects AP2, transmits an association request frame to AP2 and receives an association response frame from AP2.

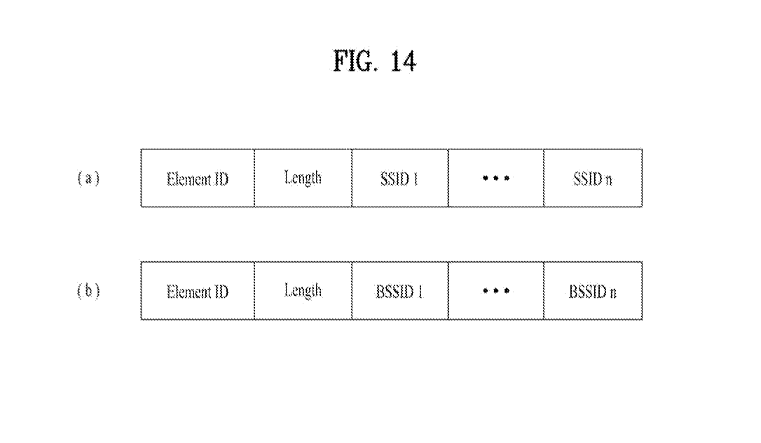

FIG. 14 illustrates formats of new IEs proposed by the present invention.

FIG. 14(a) illustrates an exemplary format of an SSID IE. The element ID field may have a length of 1 octet and may be set to a value indicating that the SSID IE relates to an SSID. The length field may have a length of 1 octet and may be set to a value indicating the length of the following field. SSID1, SSID2, . . . , SSIDn fields may be set to identifiers of APs that need to respond to a GAS request frame. The present invention provides GAS request frame multicast/broadcast transmission. Accordingly, SSIDs of one or more APs may be included in a GAS request frame.

FIG. 14(b) illustrates an exemplary format of a BSSID IE. The element ID field may have a length of 1 octet and may be set to a value indicating that the BSSID IE relates to a BSSID. The length field may have a length of 1 octet and may be set to a value indicating the length of the following field. BSSID1, BSSID2, . . . , BSSIDn fields may be set to identifiers of APs that need to respond to a GAS request frame. The present invention provides GAS request frame multicast/broadcast transmission. Accordingly, BSSIDs of one or more APs may be included in a GAS request frame.

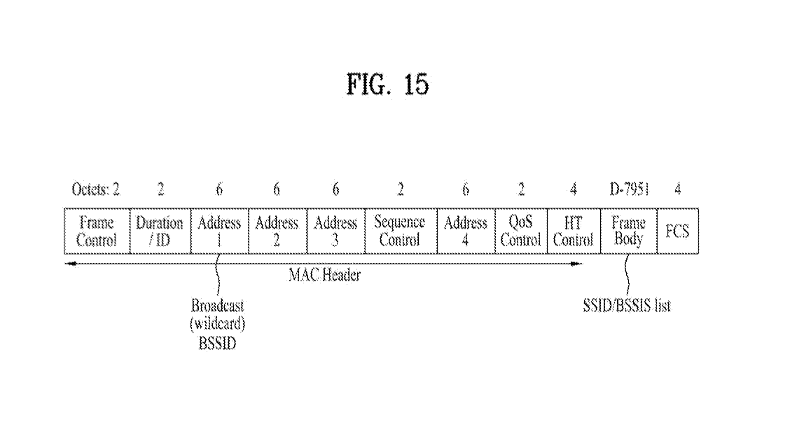

FIG. 15 illustrates an exemplary MAC frame structure of a multicast/broadcast GAS request frame according to the present invention.

A MAC frame includes a MAC header, a frame body and an FCS (Frame Check Sequence). The MAC frame may be composed of MAC PDUs (Packet Data Units) and transmitted/received through a PSDU (Physical layer Service Data Unit) of a data part of a PPDU (PLCP (Physical Layer Convergence Protocol) PDU) frame format.

In the example of FIG. 15, the MAC header includes a frame control field, a duration/ID field, address 1 field, etc. These three fields are essential in the MAC frame and other fields in the MAC header may be selectively included in the MAC header according to frame type.

The frame control field may include control information necessary to transmit/receive a frame. The duration/ID field may be set to a time for transmitting the corresponding frame. The address 1 field may be used as a receiving address. That is, the address 1 field may be set to a value corresponding to the address of a recipient (or destination) that needs to receive the corresponding MAC frame.

When the STA multicasts/broadcasts a GAS request frame to APs, the address 1 field may be set to a broadcast BSSID (or a wildcard value) in the MAC header of the GAS request frame, as shown in FIG. 15. The wildcard value may be set such that all binary values are set to a specific value (e.g. 1), which means that the wildcard value indicates all BSSIDs. Accordingly, the GAS request frame can reach APs corresponding to all BSSIDs.

One or more target SSIDs or an SSID list may be included in the body of the GAS request frame for a case in which only one or more specific APs are required to respond to the GAS request frame (i.e. multicast of the GAS request frame) and a case in which all APs are required to respond to the GAS request frame (i.e. broadcast of the GAS request frame).

When the SSID list includes one or more specific SSIDs, APs corresponding to the one or more SSIDs may be interpreted as APs that are required to respond to the GAS request frame. Accordingly, the corresponding APs may perform GAS query request/response operations for the AS.

When the SSID list is not included in the frame body or SSIDs are set to a wildcard value (e.g. a null value), all APs are required to respond to the GAS request frame. Accordingly, all APs receiving the GAS request frame can perform query request/response operations for the AS.

According to the aforementioned multicast/broadcast GAS request frame transmission method provided by the present invention, a time required for a GAS procedure performed before the STA is associated with an AP can be remarkably reduced when the STA discovers a large number of APs or networks through scanning.

The above-described enhanced GAS operation according to the present invention may be implemented such that the above-described various embodiments of the present invention can be independently applied or two or more thereof can be simultaneously applied, and description of redundant parts is omitted for clarity.

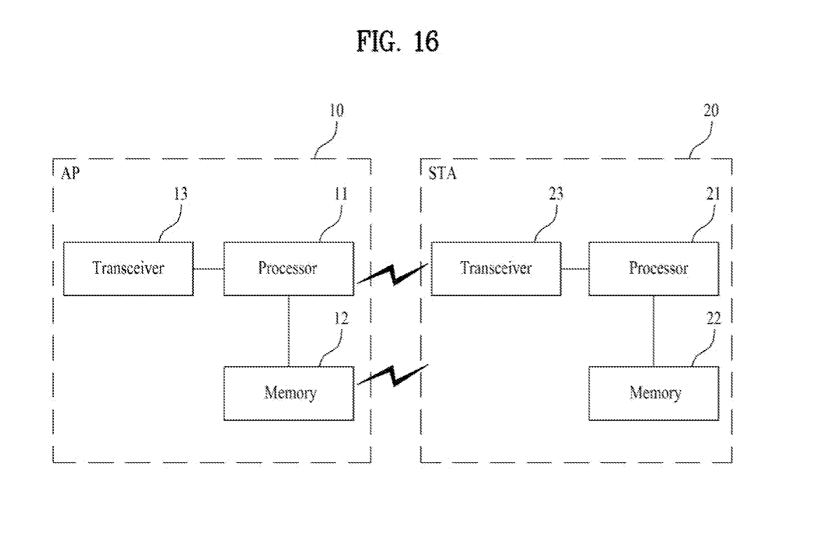

FIG. 16 is a block diagram showing exemplary configurations of an AP (or BS) and an STA (or terminal) according to an embodiment of the present invention.

An AP 10 may include a processor 11, a memory 12 and a transceiver 13. An STA 20 may include a processor 21, a memory 22 and a transceiver 23.

The transceivers 13 and 23 may transmit/receive RF signals and implement a physical layer according to IEEE 802, for example.

The processors 11 and 21 may be connected to the transceivers 13 and 23 and implement the physical layer and/or an MAC layer according to IEEE 802. The processors 11 and 21 may be configured to perform operations according to the aforementioned embodiments of the present invention or combinations of two or more thereof.

In addition, modules for implementing operations of the AP and the STA according to the aforementioned embodiments of the present invention may be stored in the memories 12 and 22 and executed by the processors 11 and 21. The memories 12 and 22 may be included in the processors 11 and 21 or provided to the outside of the processors 11 and 21 and connected to the processors 11 and 21 through known means.

Description of the AP 10 and the STA 20 may be respectively applied to a BS and a terminal in other wireless communication systems (e.g. LTE/LTE-A).

The aforementioned configurations of the AP and STA may be implemented such that the above-described various embodiments of the present invention are independently applied or two or more thereof are simultaneously applied, and description of redundant parts is omitted for clarity.

The embodiments of the present invention may be achieved by various means, for example, hardware, firmware, software, or a combination thereof.

In a hardware configuration, the methods according to the embodiments of the present invention may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the embodiments of the present invention may be implemented in the form of a module, a procedure, a function, etc. For example, software code may be stored in a memory unit and executed by a processor. The memory unit is located at the interior or exterior of the processor and may transmit and receive data to and from the processor via various known means.

The configuration of the processors 11 and 21 from among components of the AP/STA will now be described in more detail.

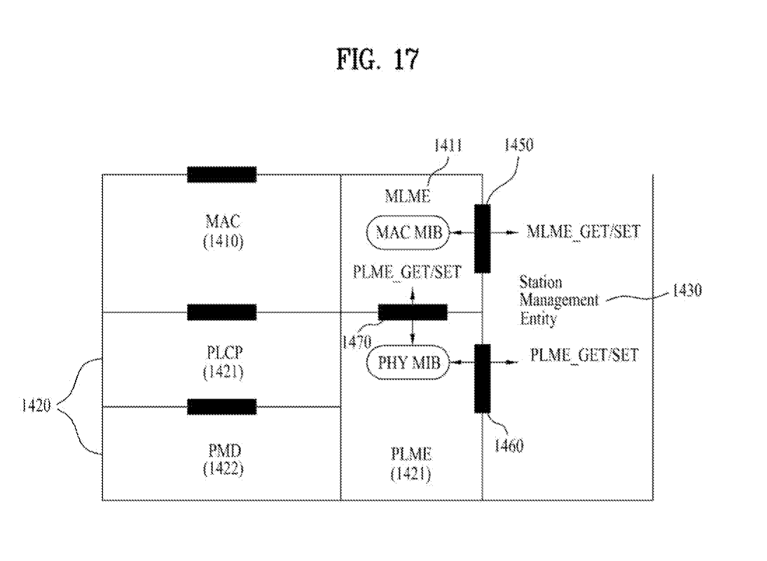

FIG. 17 illustrates an exemplary configuration of the processor of the AP or STA according to an embodiment of the present invention.

The processor 11 or 21 of the AP or STA shown in FIG. 15 may include a plurality of layers. FIG. 15 shows a MAC sublayer 1410 and a physical layer (PHY) 1420 on a data link layer DDL from among the layers. As shown in FIG. 15, the PHY 1420 may include a PLCP (Physical Layer Convergence Procedure) entity 1421 and a PMD (Physical Medium Dependent) entity 1422. Both the MAC sublayer 1410 and PHY 1420 include management entities called MLMEs (MAC sublayer Management Entities) 1411. These entities 1411 and 14121 provide a layer management service interface having a layer management function.

To provide correct MAC operation, a SME (Station Management Entity) 1430 is present in each STA. The SME 1430 is a layer independent entity which can be regarded as being present in a separate management plane or as being off to the side. While functions of the SME 1430 are not described in detail herein, the SME 1430 collects layer-dependent states from various layer management entities (LMEs) and sets layer-specific parameters to similar values. The SME 1430 may execute these functions and implement a standard management protocol on behalf of general system management entities.

The entities shown in FIG. 17 interact in various manners. FIG. 17 illustrates examples of exchanging GET/SET primitives. XX-GET.request primitive is used to request a predetermined MIB attribute (management information based attribute information). XX-GET.confirm primitive is used to return an appropriate MIB attribute information value when a status field indicates “success” and to return error indication in the status field when the status field does not indicate “success”. XX-SET.request primitive is used to request an indicated MIB attribute to be set to a predetermined value. When the MIB attribute indicates a specific operation, the MIB attribute requests the operation to be performed. XX-SET.confirm primitive is used to confirm that the indicated MIB attribute is set to a requested value when the status field indicates “success” and to return error conditions in the status field when the status field does not indicate “success”. When the MIB attribute indicates a specific operation, it is confirmed that the operation has been performed.

As shown in FIG. 17, the MLME 1411 and SME 1430 can exchange various MLME_GET/SET primitives through a MLME_SAP 1450. In addition, various PLCM_GET/SET primitives can be exchanged between the PLME 1421 and the SME 1430 through a PLME_SAP 1460 and exchanged between the MLME 1411 and the PLME 1470 through a MLME-PLME_SAP 1470.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

### INDUSTRIAL APPLICABILITY

While the above-described embodiments of the present invention focus on IEEE 802.11, they are applicable to various mobile communication systems in the same manner.

1. A method for setting up, by a station (STA), a fast link in a wireless communication system, comprising:
discovering a plurality of access points (APs) by performing scanning;
transmitting a request frame to a portion or all of the APs in a multicast or broadcast manner; and
receiving a response frame from the portion or all of the APs.

2. The method according to claim 1, wherein an AP to be associated with the STA is selected on the basis of network service information included in the received response frame.

3. The method according to claim 2, wherein the network service information is obtained through query request and response operations performed by the portion or all of the APs for an advertisement server (AS).

4. The method according to claim 3, wherein the query request and response operations for the AS are performed in parallel by the portion or all of the APs.

5. The method according to claim 1, wherein the response frame is received in parallel from the portion or all of the APs.

6. The method according to claim 1, wherein the request frame includes one or more service set identifier (SSID) information elements,
wherein the portion or all of the APs correspond to one or more SSIDs included in the one or more SSID information elements.

7. The method according to claim 1, wherein the request frame includes one or more basic service set identifier (BSSID) information elements,
wherein the portion or all of the APs correspond to one or more BSSIDs included in the one or more BSSID information elements.

8. The method according to claim 1, wherein a receiving address field of a medium access control (MAC) header of the request frame is set to a wildcard value.

9. The method according to claim 8, wherein a body of the request frame includes identification information identifying the portion or all of the APs.

10. The method according to claim 9, wherein the identification information is a target SSID list.

11. The method according to claim 9, wherein, when the identification information has a wildcard value, the request frame is transmitted to all the APs and the response frame is received from all the APs.

12. The method according to claim 1, wherein the request frame is a generic advertisement service (GAS) initial request frame and the response frame is a GAS initial response frame.

13. A method for supporting, by an AP, fast link setup in a wireless communication system, comprising:
receiving a request frame from an STA; and
transmitting a response frame to the STA,
wherein the AP is discovered through scanning performed by the STA,
wherein the request frame is transmitted from the STA to a portion or all of the APs in a multicast or broadcast manner.

14. An STA performing fast link setup in a wireless communication system, comprising:
a transceiver; and
a processor,
wherein the processor is configured to discover a plurality of APs through scanning, to transmit a request frame to a portion or all of the APs in a multicast or broadcast manner using the transceiver and to receive a response frame from the portion or all of the APs using the transceiver.

15. An AP supporting fast link setup in a wireless communication system, comprising:
a transceiver; and
a processor,
wherein the processor is configured to receive a request frame from an STA using the transceiver and to transmit a response frame to the STA using the transceiver,
wherein the AP is discovered through scanning performed by the STA,
wherein the request frame is transmitted from the STA to a portion or all of the APs in a multicast or broadcast manner.
